(19) United States
(12) Patent Application Publication
(10) Pub. No.: US 2021/0067278 A1
(43) Pub. Date: Mar. 4, 2021

(54) WIRELESS COMMUNICATION APPARATUS

(71) Applicant: KABUSHIKI KAISHA TOSHIBA, Tokyo (JP)

(72) Inventors: Toshihisa NABETANI, Kawasaki Kanagawa (JP); Masahiro SEKIYA, Inagi Tokyo (JP)

(73) Assignee: KABUSHIKI KAISHA TOSHIBA, Tokyo (JP)

(21) Appl. No.: 16/804,780

(22) Filed: Feb. 28, 2020

(30) Foreign Application Priority Data
Aug. 30, 2019 (JP) 2019-158376

(51) Int. Cl. H04L 1/18; H04L 1/20; H04L 5/00; H04W 72/04

(52) U.S. Cl. CPC H04L 1/1816; H04W 72/0446; H04L 5/0055; H04L 1/203

(57) ABSTRACT

According to one embodiment, a wireless communication apparatus includes transmitter circuitry, receiver circuitry and control circuitry. The transmitter circuitry transmits a first frame including first data. The receiver circuitry receives, if the first frame is received by at least a first wireless communication apparatus and a second wireless communication apparatus, a second frame indicating a reception status of the first data by the first wireless communication apparatus and a third frame indicating a reception status of the first data by the second wireless communication apparatus. The control circuitry determines not retransmitting the first data if at least one of the second frame and the third frame indicates that reception has succeeded.

### CROSS-REFERENCE TO RELATED APPLICATIONS

This application is based upon and claims the benefit of priority from Japanese Patent Application No. 2019-158376, filed Aug. 30, 2019, the entire contents of which are incorporated herein by reference.

### FIELD

Embodiments described herein relate generally to a wireless communication apparatus.

### BACKGROUND

Recently, various technologies for improving reliability of communication have been proposed. One of the technologies is a route diversity technology with which one item of data is transmitted using a plurality of paths. With this technology, it is possible to provide redundancy to the path. Therefore, even if data transmission using one path has failed, the data can be transmitted using the other path. As a result, the reliability of communication can be improved.

However, this technology has the following disadvantages. That is, it takes time to determine that data transmission using one path has failed. In addition, when it is determined that data transmission using one path has failed, it is necessary to switch the path used for data transmission, and it takes time to switch the path. Therefore, with this technology, it may be difficult to handle instantaneous degradation of communication quality. Consequently, there is demand for a new technology to overcome these disadvantages.

### BRIEF DESCRIPTION OF THE DRAWINGS

FIG. 1 is an illustration showing a schematic configuration example of a wireless communication system according to the first embodiment.

FIG. 2 is an illustration showing a configuration example of a data reception side wireless communication apparatus in the first embodiment.

FIG. 3 is an illustration showing a configuration example of a data transmission side wireless communication apparatus in the first embodiment.

FIG. 4 is an illustration showing a format example of a trigger frame in the first embodiment.

FIG. 5 is another illustration showing the format example of the trigger frame in the first embodiment.

FIG. 6 is an illustration showing the general outline of the operation of the wireless communication system in the first embodiment.

FIG. 7 is another illustration showing the general outline of the operation of the wireless communication system in the first embodiment.

FIG. 8 is a flowchart showing an operation example of the data transmission side wireless communication apparatus in the first embodiment.

FIG. 9 is an illustration showing the general outline of the operation of a wireless communication system in the second embodiment.

### DETAILED DESCRIPTION

Embodiments will be described hereinafter with reference to the accompanying drawings. The disclosure is merely an example, and the invention is not limited by the contents described in the following embodiments. Modifications which are easily conceivable by a person of ordinary skill in the art come within the scope of the disclosure as a matter of course.

In general, according to one embodiment, a wireless communication apparatus includes transmitter circuitry, receiver circuitry and control circuitry. The transmitter circuitry is configured to transmit a first frame including first data. The receiver circuitry is configured to receive, if the first frame is received by at least a first wireless communication apparatus and a second wireless communication apparatus, a second frame indicating a reception status of the first data by the first wireless communication apparatus using a first communication resource and a third frame indicating a reception status of the first data by the second wireless communication apparatus using a second communication resource different from the first communication resource. The control circuitry is configured to determine not retransmitting the first data if at least one of the reception status of the first data indicated by the second frame and the reception status of the first data indicated by the third frame indicates that reception has succeeded.

### First Embodiment

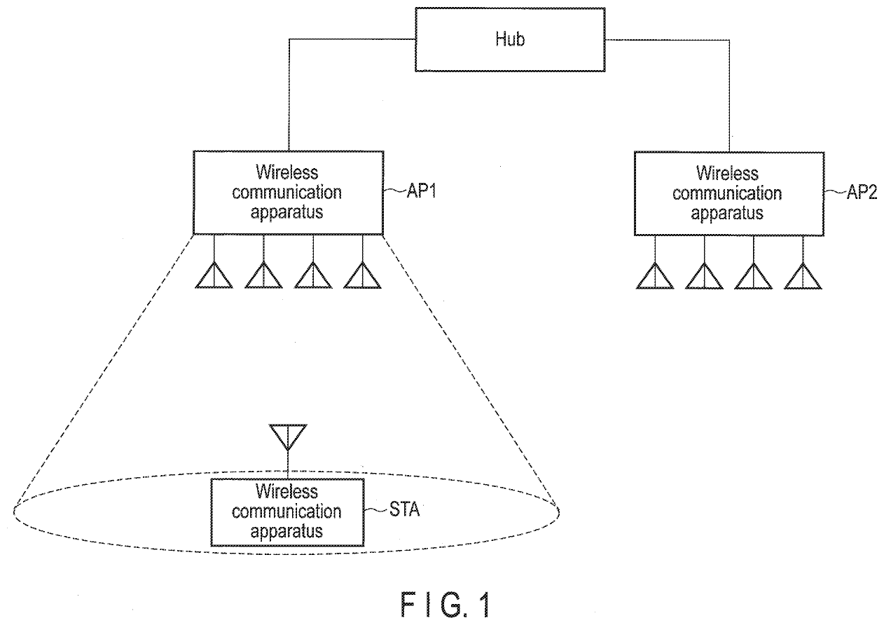

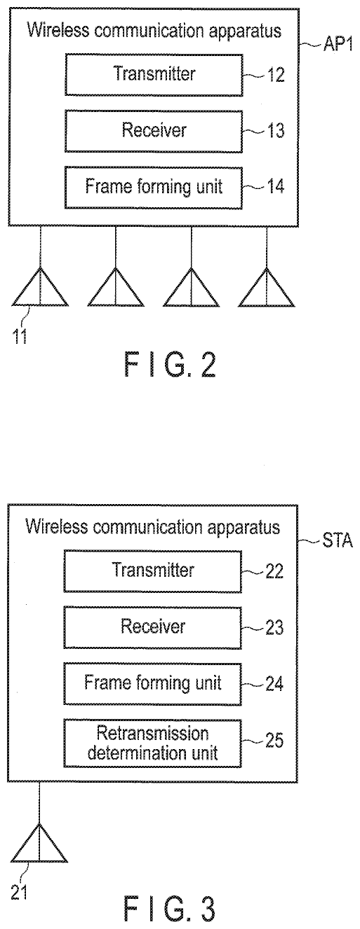

FIG. 1 shows a schematic configuration example of a wireless communication system including a wireless communication apparatus according to the first embodiment. A data transmission side wireless communication apparatus (station (STA) shown in FIG. 1) and data reception side wireless communication apparatuses (access point (AP)1 and AP2 shown in FIG. 2) are arranged in the wireless communication system shown in FIG. 1. Note that a wireless communication apparatus other than a data transmission side wireless communication apparatus and a data reception side wireless communication apparatus may be further included in the wireless communication system.

The data transmission side wireless communication apparatus is a wireless communication apparatus which transmits a data frame including predetermined data and receives an acknowledgment frame indicating that the predetermined data has normally been received without errors. The data reception side wireless communication apparatus is a wireless communication apparatus which receives the data frame and transmits (returns) the acknowledgment frame if the wireless communication apparatus has normally received predetermined data included in the data frame. Note that the data frame here is not necessarily a data frame but may be, for example, a control frame.

When the data transmission side wireless communication apparatus receives the acknowledgment frame, and if the data transmission side wireless communication apparatus acknowledges that the data reception side wireless communication apparatus has received the predetermined data without errors, the data transmission side wireless communication apparatus determines not retransmitting the predetermined data. On the other hand, if the data transmission side wireless communication apparatus does not receive the acknowledgment frame within a predetermined time period, the data transmission side wireless communication apparatus determines retransmitting the predetermined data as needed.

In the present embodiment, a frame in a wireless LAN system of an IEEE 802.11 standard is used between the data transmission side wireless communication apparatus and the data reception side wireless communication apparatus. IEEE 802.11 standards include IEEE 802.11a, IEEE 802.11b, IEEE 802.11g, IEEE 802.11n, IEEE 802.11ac and IEEE 802.11ax and also include IEEE 802.11 standards to be defined in the future. Note that the frame used between the data transmission side wireless communication apparatus and the data reception side wireless communication apparatus is not limited to the frame in the wireless LAN system of the IEEE 802.11 standard but may be a frame in an arbitrary wireless communication system.

In the present embodiment, the wireless communication apparatus STA shown in FIG. 1 is a data transmission side wireless communication apparatus, and the wireless communication apparatus AP is a data reception side wireless communication apparatus. However, they are not limited to this. The wireless communication apparatus AP may be a data transmission side wireless communication apparatus, and the wireless communication apparatus STA may be a data reception side wireless communication apparatus.

In addition, in the present embodiment, the wireless communication apparatus STA shown in FIG. 1 only has an association connection with the wireless communication apparatus AP1. However, it is not limited to this. The wireless communication apparatus STA may also have an association connection with the wireless communication apparatus AP2 in addition to the wireless communication apparatus AP1. In that case, the wireless communication apparatus STA belongs to both a network (BSS) which the wireless communication apparatus AP1 forms and a BSS which the wireless communication apparatus AP2 forms.

In the present embodiment, the wireless communication apparatuses AP1 and AP2 are connected to each other via a cable. However, they are not limited to this. The wireless communication apparatuses AP1 and AP2 may be connected to each other by wireless communication.

In FIG. 1, one wireless communication apparatus AP2 is illustrated as the wireless communication apparatus AP which does not have an association connection with the wireless communication apparatus STA. However, it is not limited to this. The wireless communication system may include more wireless communication apparatuses AP corresponding to the wireless communication apparatus AP2.

The wireless communication system shown in FIG. 1 is an infrastructure mode network system composed of a wireless communication apparatus STA and a wireless communication apparatus AP. However, it is not limited to this. The wireless communication system shown in FIG. 1 may be, for example, an ad-hoc mode network system in which a plurality of wireless communication apparatuses STA perform direct communication without intervention of wireless communication apparatus AP. In this case, the wireless communication apparatuses AP1 and AP2 shown in FIG. 1 are replaced with wireless communication apparatuses STA, and one of three wireless communication apparatuses STA operates as an owner in an ad-hoc network.

In addition, in the wireless communication system shown in FIG. 1, multiuser multiplexing communication can be performed between the wireless communication apparatus STA and the wireless communication apparatuses AP1 and AP2. That is, transmission and reception of a frame between the wireless communication apparatus STA and the wireless communication apparatus AP1 and transmission and reception of a frame between the wireless communication apparatus STA and the wireless communication apparatus AP2 can be simultaneously performed.

Examples of the multiuser multiplexing communication are orthogonal frequency-division multiple access (OFDMA) using different frequency components as orthogonal communication resources, multiuser multiple-input and multiple-output (MIMO) which performs spatially orthogonal communication by beam control using a plurality of antennas, code-division multiple access (CDMA) using different codes as orthogonal communication resources, and the like. However, it may be multiuser multiplexing communication which simultaneously performs multiplexing communication using communication resources other than those described above.

In the present embodiment, OFDMA is used as the multiuser multiplexing communication. In OFDMA in the present embodiment, one or more sub-carriers are defined as a resource unit (RU) which is a minimum communication resource unit, one frequency channel is divided into a plurality of resource units, and the resource units are used for performing communication with a plurality of wireless communication apparatuses. Consequently, it is possible to simultaneously receive frames from a plurality of wireless communication apparatuses without interference and simultaneously transmit a frame to a plurality of wireless communication apparatuses without interference.

For example, in a case where one frequency channel is divided into nine resource units, one wireless communication apparatus can simultaneously transmit a frame to and receives frames from a maximum of nine wireless communication apparatuses. The relationship between the resource unit and the wireless communication apparatus is not necessarily a one-to-one relationship, and for example, three resource units may be used by one wireless communication apparatus. In addition, the number of resource units used by one wireless communication apparatus is not necessarily the same as the number of resource units used by the other wireless communication apparatus. That is, the number of resource units used by one wireless communication apparatus may be one, and the number of resource units used by the other wireless communication apparatus may be two.

FIG. 2 shows a configuration example of the data reception side wireless communication apparatus in the first embodiment (the wireless communication apparatuses AP1 and AP2 in the present embodiment). In FIG. 2, the configuration of the wireless communication apparatus AP1 will be described as an example. However, the same also applies to the configuration of the wireless communication apparatus AP2.

The wireless communication apparatus AP1 includes a transmission/reception antenna 11, a transmitter 12 (transmitter circuitry) which transmits a frame via the antenna 11, and a receiver 13 (receiver circuitry) which receives a frame transmitted from the wireless communication apparatus STA via the antenna 11, and a frame forming unit 14 which forms a frame to be transmitted. This configuration is realized by, for example, a semiconductor integrated circuit (LSI), etc. Although the wireless communication apparatus AP1 includes four antennas 11 here, the number of antennas 11 is not limited to this.

The transmitter 12 transmits a frame via the antenna 11. The transmitter 12 can transmit a frame in a wireless LAN system of an IEEE 802.11 standard such as a trigger frame, a data frame, an acknowledgment frame or a management frame. At this time, the transmitter 12 can multiplex a frame which the transmitter 12 transmits and a frame which the other data reception side wireless communication apparatus (in the present embodiment, for example, the wireless communication apparatus AP2) transmits, and can simultaneously transmit these frames.

The receiver 13 receives a frame transmitted from the wireless communication apparatus STA via the antenna 11. The receiver 13 can receive a frame in a wireless LAN system of an IEEE 802.11 standard such as a trigger frame, a data frame, an acknowledge frame or a management frame. The receiver 13 checks whether the receiver 13 has received the frame without errors (the reception has succeeded) or not, and if the reception has succeeded, the receiver 13 instructs the frame forming unit 14 to form an acknowledgment frame for the wireless communication apparatus STA which has transmitted the frame. In addition, even if the destination of a frame is not the own apparatus, the receiver 13 can receive radio waves and restore the frame. The method of receiving a frame which is not directed to the own apparatus will be described later, and its detailed description will be omitted here.

The frame forming unit 14 forms a frame used for communication, and instructs the transmitter 12 to transmit the frame. The frame forming unit 14 can form a frame in a wireless LAN system of an IEEE 802.11 standard such as a trigger frame, a data frame, an acknowledgment frame or a management frame. In the present embodiment, an acknowledgment frame is formed in the frame forming unit 14, and an Ack frame or a Block Ack frame is used as the acknowledgment frame.

FIG. 3 shows a configuration example of the data transmission side wireless communication apparatus in the first embodiment (the wireless communication apparatus STA in the present embodiment).

The wireless communication apparatus STA includes a transmission/reception antenna 21, a transmitter 22 (transmitter circuitry) which transmits a frame via the antenna 21, a receiver 23 (receiver circuitry) which receives frames transmitted from the wireless communication apparatuses AP1 and AP2 via the antenna 21, a frame forming unit 24 which forms a frame to be transmitted, and a retransmission determination unit 25 (control circuitry) which determines whether to retransmit data which has already been transmitted once. This configuration is realized by, for example, a semiconductor integrated circuit. Although the wireless communication apparatus STA includes one antenna 21 here, the number of antennas 21 is not limited to this.

The transmitter 22 transmits a frame via the antenna 21. The transmitter 22 can transmit a frame in a wireless LAN system of an IEEE 802.11 standard such as a trigger frame, a data frame, an acknowledgment frame or a management frame.

The receiver 23 receives frames transmitted from the wireless communication apparatuses AP1 and AP2 via the antenna 21. The receiver 23 can receive a frame in a wireless LAN system of an IEEE 802.11 standard such as a trigger frame, a data frame, an acknowledge frame or a management frame. The receiver 23 can receive multiplexed frames and demultiplex the multiplexed frames into frames before the multiplexing.

The frame forming unit 24 forms a frame used for communication, and instructs the transmitter 22 to transmit the frame. The frame forming unit 24 can form a frame in a wireless LAN system of an IEEE 802.11 standard such as a trigger frame, a data frame, an acknowledgment frame or a management frame. In the present embodiment, a data frame and a trigger frame are formed in the frame forming unit 24, and a MAC frame is used as the data frame and a frame in a format which will be described later is used as the trigger frame.

The retransmission determination unit 25 determines whether to retransmit data which has already been transmitted once according to the acknowledgment frames transmitted from the wireless communication apparatuses AP1 and AP2. In the present embodiment, if an acknowledgment frame is received from at least one of the wireless communication apparatuses AP1 and AP2, the retransmission determination unit 25 determines not to retransmit data which has already been transmitted once. On the other hand, if an acknowledgment frame is not received from either of the wireless communication apparatuses AP1 and AP2, the retransmission determination unit 25 determines to retransmit data which has already been transmitted once.

Here, for the sake of convenience of explanation, the transmitter 12, the receiver 13 and the frame forming unit 14 of the data reception side wireless communication apparatus, and the transmitter 22, the receiver 23 and the frame forming unit 24 of the data transmission side wireless communication apparatus have been explained in different manners. However, in reality, the data reception side wireless communication apparatus and the data transmission side wireless communication apparatus are the same as each other except the presence or absence of the retransmission determination unit 25, and the transmitter 12, the receiver 13 and the frame forming unit 14 of the data reception side wireless communication apparatus, and the transmitter 22, the receiver 23 and the frame forming unit 24 of the data transmission side wireless communication apparatus function in the same manners, respectively. That is, as is the case with the receiver 23 of the data transmission side wireless communication apparatus, the receiver 13 of the data reception side wireless communication apparatus can receive multiplexed frames and demultiplex the multiplexed frames into frames before the multiplexing. In addition, as is the case with the transmitter 12 of the data reception side wireless communication apparatus, the transmitter 22 of the data transmission side wireless communication apparatus can multiplex a plurality of frames to be transmitted and simultaneously transmit a plurality of frames.

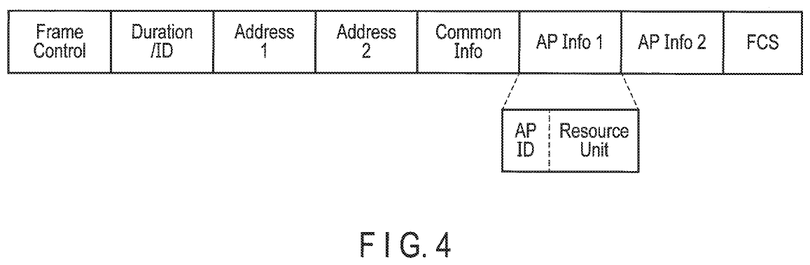

FIG. 4 shows an example of the format of the trigger frame used in the present embodiment.

The trigger frame in the present embodiment is one of frames which the data transmission side wireless communication apparatus (the wireless communication apparatus STA in the present embodiment) transmits to the data reception side wireless communication apparatus (the wireless communication apparatuses AP1 and AP2 in the present embodiment).

This trigger frame includes a command which requests the data reception side wireless communication apparatus to transmit (return) an acknowledgment frame. In addition, this trigger frame can designate the setting of the transmission of the acknowledgment frame of the data reception side wireless communication apparatus. In the present embodiment, a resource unit which is used when each data reception side wireless communication apparatus transmits the acknowledgment frame by OFDMA is designated in this setting.

Various fields forming the trigger frame will be described below. Fields other than a Common Info field and an AP Info field are the same as fields included in a general MAC header, and fields may be added or deleted as needed.

A Frame Control field includes Type field and a Subtype field, which are not illustrated in the drawing. The data reception side wireless communication apparatus refers to this Type field and this Subtype field, and recognizes receiving a trigger frame.

In a Duration/ID field, information such as a transmission prohibition period (network allocation vector: NAV) is set.

In an Address 1 field, includes information indicating a wireless communication apparatus which is the destination of a trigger frame is set. The information indicating the destination wireless communication apparatus may be the MAC address of the wireless communication apparatus or may be a unique ID of the apparatus which is associated in a one-to-one correspondence with the MAC address. In the present embodiment, it is assumed that the trigger frame is transmitted to the wireless communication apparatuses AP1 and AP2. Therefore, information indicating the wireless communication apparatuses AP1 and AP2 is set in the Address 1 field. Note that a multicast address or a broadcast address corresponding to the wireless communication apparatuses AP1 and AP2 may be set in the Address 1 field.

In an Address 2 field, information indicating a wireless communication apparatus which is the transmission source (the sender) of a trigger frame is set. As is the case with the Address 1 field, the information indicating the transmission source of the wireless communication apparatus may be the MAC address of the wireless communication apparatus or may be a unique ID of the apparatus which is associated in a one-to-one correspondence with the MAC address. In the present embodiment, it is assumed that the trigger frame is transmitted from the wireless communication apparatus STA. Therefore, information indicating the wireless communication apparatus STA is set in the Address 2 field.

In a Common Info field, information commonly notified to a plurality of data reception side wireless communication apparatuses is set. In the present embodiment, it is assumed that there are two data reception side wireless communication apparatuses AP1 and AP2. Therefore, information commonly notified to the wireless communication apparatuses AP1 and AP2 is set in the Common Info field.

More specifically, information about designation of the physical header of a frame to be transmitted by OFDMA (a transmission acknowledgment frame in the present embodiment), information about designation of a frame type, information about designation of a frame length, information about control of transmission power, and the like, are set in the Common Info field. The data reception side wireless communication apparatus refers to this Common Info field, and determines the physical header of the acknowledgment frame to be transmitted when the reception of data included in the data frame succeeds, the frame type of the acknowledgment frame, the frame length of the acknowledgment frame, the transmission power at which the acknowledgment frame is transmitted, and the like.

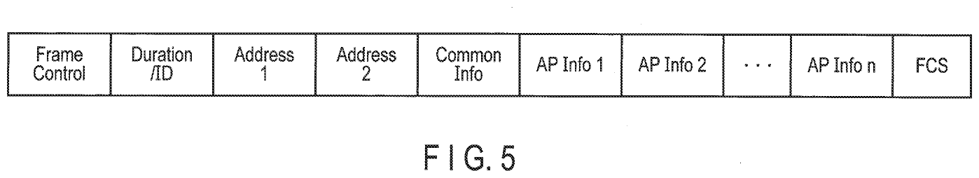

In an AP Info field, information individually notified to a plurality of data reception side wireless communication apparatuses is set. The number of AP Info fields is the same as the number of data reception side wireless communication apparatuses (more specifically, the number of wireless communication apparatuses requested to return an acknowledgment frame). In the present embodiment, it is assumed that there are two data reception side wireless communication apparatuses AP1 and AP2. Therefore, two AP Info fields (AP Info 1 field and AP Info 2 field) are included in the trigger frame as shown in FIG. 4. In general terms, when the number of wireless communication apparatuses requested to return an acknowledgment frame is n, n AP Info fields (AP Info 1 field to AP Info n field) are included in the trigger frame as shown in FIG. 5.

In the AP Info field, at least identification information identifying a wireless communication apparatus to which information is individually notified, and information individually notified to the wireless communication apparatus identified by the identification information are included. More specifically, an AP ID and a Resource Unit are included as shown in FIG. 4.

The AP ID is identification information identifying a wireless communication apparatus, and for example, may be the MAC address of the wireless communication apparatus or may be a unique ID of the apparatus which is associated in a one-to-one correspondence with the MAC address. The data reception side wireless communication apparatus refers to this AP ID, and recognizes an AP Info field directed to the own apparatus.

In the Resource Unit, information designating a resource unit which is used when an acknowledgment frame is transmitted is set. The data reception side wireless communication apparatus refers to this Resource Unit, and recognizes a resource unit (sub-carrier) which is used when the owner apparatus transmits an acknowledgment frame by OFDMA.

In addition to the AP ID and the Resource Unit, information designating a modulation and coding scheme (MCS) which is used when an acknowledgment frame is transmitted, and the like may be further included in the AP Info field.

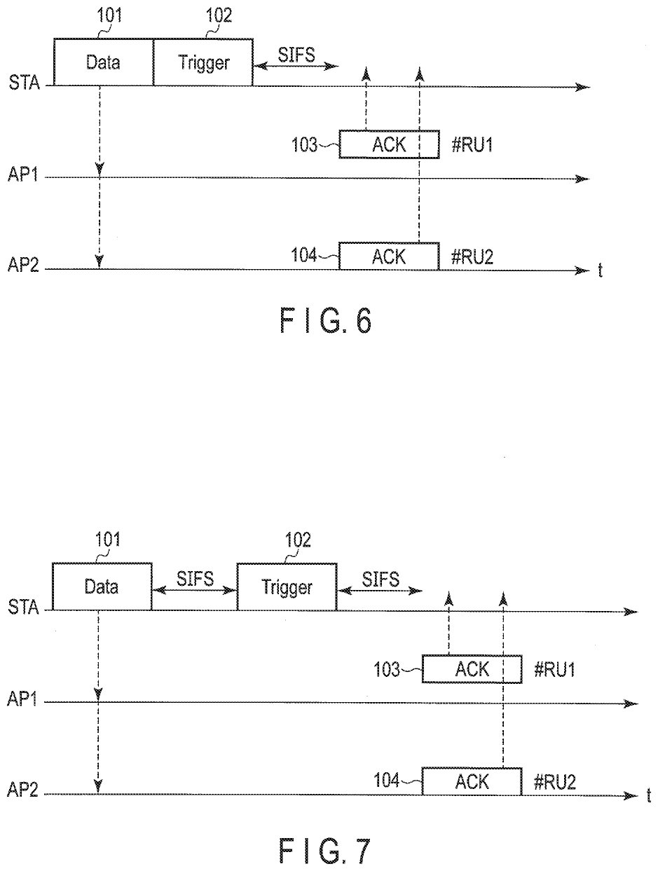

Here, the general outline of the operation of the wireless communication system in the first embodiment will be described with reference to FIG. 6. Here, it is assumed that a data frame 101 transmitted from the wireless communication apparatus STA is a frame directed to the wireless communication apparatus AP1. Although the destination of a data frame 101 here is the wireless communication apparatus AP1 as described above, the destination of a data frame 101 may be the wireless communication apparatus AP2. In this case, the wireless communication apparatus AP1 performs operation corresponding to the operation of the wireless communication apparatus AP2 which will be described later, and the wireless communication apparatus AP2 performs operation corresponding to the operation of the wireless communication apparatus AP1 which will be described later.

Firstly, one physical frame into which a data frame 101 and a trigger frame 102 are integrated is transmitted by the data transmission side wireless communication apparatus STA, and the physical frame is received by the data reception side wireless communication apparatuses AP1 and AP2.

Here, it is assumed that the following information is set in the trigger frame 102, that is, information requesting each of the wireless communication apparatuses AP1 and AP2 to return an acknowledgment frame notifying whether data included in the data frame 101 has been received without errors (reception has succeeded) or not and requesting each of the wireless communication apparatuses AP1 and AP2 to return the acknowledgment frame by OFDMA using a designated resource unit.

When the wireless communication apparatus AP1 receives the data frame 101 and the trigger frame 102 and if the wireless communication apparatus AP1 recognizes that the data frame 101 is directed to the own apparatus (or recognizes that the wireless communication apparatus AP1 is requested to return an acknowledgment frame by the trigger frame 102), the wireless communication apparatus AP1 checks whether the wireless communication apparatus AP1 has received data included in the data frame 101 without error or not. If the reception has succeeded, the wireless communication apparatus AP1 uses a resource unit “#RU1” designated by the trigger frame 102 and transmits an acknowledgment frame 103 directed to the wireless communication apparatus STA. The acknowledgment frame 103 is transmitted after the elapse of a predetermined time called short inter-frame spacing (SIFS) from the trailing end of the received physical frame (that is, the trailing end of the trigger frame 102).

In addition, when the wireless communication apparatus AP2 receives the data frame 101 and the trigger frame 102 and if the wireless communication apparatus AP2 recognizes that the wireless communication apparatus AP2 is requested to return an acknowledgment frame by the trigger frame 102 (more specifically, when the wireless communication apparatus AP2 refers to an AP Info field included in the trigger frame 102 and if the wireless communication apparatus AP2 recognizes that there is an AP info field indicating the AP ID of the own apparatus), the wireless communication apparatus AP2 checks whether the wireless communication apparatus AP2 has received data included in the data frame 101 originally directed to the other apparatus without errors or not. If the reception has succeeded, the wireless communication apparatus AP2 uses a resource unit “#RU2” designated by the trigger frame 102 and transmits an acknowledgment frame 104 directed to the wireless communication apparatus STA. As is the case with the above-described acknowledgment frame 103, the acknowledgment frame 104 is transmitted after the elapse of SIFS from the trailing end of the trigger frame 102. Here, it is assumed that, when the wireless communication apparatus AP2 refers to an AP Info field included in the trigger frame 102 and if there is an AP Info field indicating the AP ID of the own apparatus, the wireless communication apparatus AP2 recognizes that the wireless communication apparatus AP2 is requested to return an acknowledgment frame. However, it is not limited to this. The wireless communication apparatus AP2 may recognize that the wireless communication apparatus AP2 is requested to return an acknowledgment frame with reference to the other field (for example, a Common Info field or an Address 1 field).

As described above, the acknowledgment frames 103 and 104 which the wireless communication apparatuses AP1 and AP2 transmit, respectively, are multiplexed using different resource units designated by the trigger frame 102 (in this case, the resource units “#RU1” and “#RU2”) and simultaneously transmitted to the destination wireless communication apparatus STA.

If the wireless communication apparatus STA receives at least one of the acknowledgment frame 103 transmitted from the wireless communication apparatus AP1 and the acknowledgment frame 104 transmitted from the wireless communication apparatus AP2, the wireless communication apparatus STA determines not retransmitting data included in the data frame 101. That is, even when the acknowledgment frame 103 is not transmitted from the wireless communication apparatus AP1 which is the original destination of data, if the acknowledgment frame 104 is transmitted from the wireless communication apparatus AP2, the wireless communication apparatus STA determines not retransmitting data included in the data frame 101. The reason is that, even when the reception of the data included in the data frame 101 has failed in the wireless communication apparatus AP1 which is the original destination of the data, if the data included in the data frame 101 is received without errors in the wireless communication apparatus AP2 connected to the wireless communication apparatus AP1 by wired or wireless communication, the data included in the data frame 101 can be transferred (transmitted) from the wireless communication apparatus AP2 to the wireless communication apparatus AP1.

On the other hand, if the wireless communication apparatus STA has not received either of the acknowledgment frame 103 transmitted from the wireless communication apparatus AP1 and the acknowledgment frame 104 transmitted from the wireless communication apparatus AP2, the wireless communication apparatus STA determines retransmitting the data included in the data frame 101.

As described above, in the wireless communication system of the present embodiment, in response to one item of data included in the data frame 101 transmitted from the data transmission side wireless communication apparatus STA, the acknowledgment frames 103 and 104 can be simultaneously transmitted by OFDMA using different resources units (orthogonal resource units) designated in the trigger frame 102.

In FIG. 6, the data frame 101 and the trigger frame 102 are arranged in this order and integrated into the physical frame. However, the order of the frames integrated into the physical frame is not limited to this. For example, the order of the frames integrated into the physical frames may be the order of the trigger frame 102 and the data frame 101.

In addition, although the resource unit “#RU1” is used for (assigned to) the wireless communication apparatus AP1 and the resource unit “#RU2” is used for (assigned to) the wireless communication apparatus AP2 in FIG. 6, the resource unit “#RU2” may be used for the wireless communication apparatus AP1 and the resource unit “#RU1” may be used for the wireless communication apparatus AP2.

Furthermore, in FIG. 6, in order to request the wireless communication apparatus AP2 to return the acknowledgment frame 104 indicating the reception success/failure result of the data (the reception status of the data) included in the data frame 101 originally directed to the other apparatus, the return of the acknowledgment frame is requested by the trigger frame 102. However, the method of requesting the return of the acknowledgment frame in response to the data included in the data frame directed to the other apparatus is not limited to this. For example, with regard to data included in a data frame directed to a predetermined wireless communication apparatus (in this case, the wireless communication apparatus AP1), by setting return of an acknowledgment frame regardless of whether the own apparatus (in this case, the wireless communication apparatus AP2) is a destination or not in advance and storing information indicating the predetermined wireless communication apparatus in the own apparatus in advance, it is possible to realize the return of the acknowledgment frame to the data included in the data frame directed to the other apparatus.

Note that, with regard to the setting that the acknowledgment frame is always returned in response to the data included in the data frame including the wireless communication apparatus AP1 as a destination, the wireless communication apparatus AP2 may register information indicating the wireless communication apparatus AP1 in the own apparatus with a negotiation with the wireless communication apparatus AP1 in advance, or the wireless communication apparatus AP2 may register information indicating the wireless communication apparatus AP1 without the negotiation with the wireless communication apparatus AP1. The information indicating the wireless communication apparatus AP1 registered in the wireless communication apparatus AP2 may be the MAC address of the wireless communication apparatus AP1 or may be a unique ID of the apparatus associated in a one-to-one correspondence with the MAC address.

As described above, according to the method of realizing the return of an acknowledgment frame by setting information about a destination which is requested to return an acknowledgement frame and storing the information in a data reception side wireless communication apparatus in advance, even if the data reception side wireless communication apparatus receives a data frame in which a multicast address or a broadcast address corresponding to a plurality of wireless communication apparatuses is set as a destination, the data reception side wireless communication apparatus can still return an acknowledgment frame indicating the reception success/failure result of data included in the data frame.

In general, when each wireless communication apparatus receives a data frame in which a multicast address or a broadcast address is set as a destination, the wireless communication apparatus does not return an acknowledgment frame in response to data included in the data frame. However, as described above, information about a multicast address or a broadcast address as a destination to which an acknowledgment frame is returned is set in advance and the information is stored. Consequently, each wireless communication apparatus can return an acknowledgment frame in response to data included in the data frame.

In FIG. 6, the data frame 101 and the trigger frame 102 are integrated into one physical frame and transmitted. However, they are not limited to this. For example, as shown in FIG. 7, the data frame 101 and the trigger frame 102 may be transmitted with a space corresponding to SIFS in between, just like burst transmission. In this case also, it is possible to simultaneously transmit the acknowledgment frames 103 and 104 by transmitting the acknowledgment frames 103 and 104 after the elapse of SIFS from the reception of the trigger frame 102.

In FIGS. 6 and 7, the acknowledgment frames 103 and 104 are transmitted after the elapse of SIFS from the trailing end of the trigger frame 102, and consequently, the wireless communication apparatuses AP1 and AP2 realize simultaneous transmission of acknowledgment frames. However, the method of simultaneously transmitting acknowledgment frames from the wireless communication apparatuses AP1 and AP2 is not limited to this. For example, transmission timings at which the wireless communication apparatuses AP1 and AP2 transmit acknowledgment frames may be designated by (the Common Info field, etc., of) the trigger frame 102, and the wireless communication apparatuses AP1 and AP2 may thereby realize simultaneous transmission of acknowledgment frames.

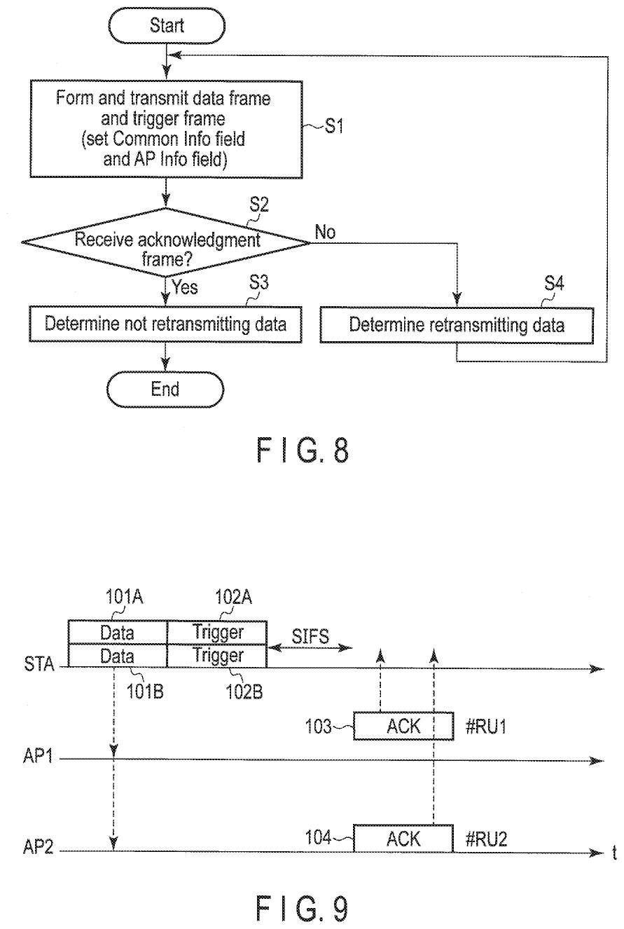

FIG. 8 is a flowchart for more specifically explaining the operation of the data transmission side wireless communication apparatus STA included in the wireless communication system, the general outline of the operation of which has been shown in FIG. 6.

Firstly, the frame forming unit 24 of the data transmission side wireless communication apparatus STA forms the data frame 101 and the trigger frame 102 which are directed to the wireless communication apparatus AP1, and instructs the transmitter 22 to transmit one physical frame into which the data frame 101 and the trigger frame 102 are integrated. According to the instruction from the frame forming unit 24, the transmitter 22 transmits one physical frame including the data frame 101 and the trigger frame 102 to the wireless communication apparatuses AP1 and AP2 (step S1).

In order to form the trigger frame 102, the frame forming unit 24 sets information indicating the wireless communication apparatuses AP1 and AP2 in the Address 1 field. The frame forming unit 24 may set a multicast address or a broad cast address corresponding to the wireless communication apparatuses AP1 and AP2 in the Address 1 field.

Next, the frame forming unit 24 sets information indicating the own apparatus (that is, the wireless communication apparatus STA) in the Address 2 field.

Subsequently, the frame forming unit 24 sets information commonly notified to the wireless communication apparatuses AP1 and AP2 in the Common Info field. More specifically, as described above, the frame forming unit 24 sets information indicating the physical header of an acknowledgment frame to be transmitted by OFDMA, the frame type, the frame length, the transmission power at which the acknowledgment frame is transmitted, and the like in the Common Info field.

Furthermore, the frame forming unit 24 sets information individually notified to the wireless communication apparatuses AP1 and AP2 in the AP Info fields. More specifically, the frame forming unit 24 sets information individually notified to the wireless communication apparatus AP1 in the AP Info 1 field, and sets information individually notified to the wireless communication apparatus AP2 in the AP Info 2 field.

The frame forming unit 24 sets the AP ID of the wireless communication apparatus AP1 as the AP ID included in the AP Info 1 field, and sets information indicating the resource unit “#RU1” as the Resource Unit included in the AP Info 1 field.

Similarly, the frame forming unit 24 sets the AP ID of the wireless communication apparatus AP2 as the AP ID included in the AP Info 2 field, and sets information indicating the resource unit “#RU2” as the Resource Unit included in the AP Info 2 field.

After the frame forming unit 24 forms the trigger frame 102 as described above, the physical frame into which the data frame 101 and the trigger frame 102 are integrated is transmitted to the wireless communication apparatuses AP1 and AP2 via the transmitter 22.

As described above with reference to FIG. 6, the wireless communication apparatuses AP1 and AP2, which are data reception side wireless communication apparatuses, refer to the Common Info field and the AP Info fields included in the trigger frame 102 and form the acknowledgment frames 103 and 104, respectively, and the wireless communication apparatus AP1 transmits the acknowledgment frame 103 to the wireless communication apparatus STA using the resource unit “#RU1”, and the wireless communication apparatus AP2 transmits the acknowledgment frame 104 to the wireless communication apparatus STA using the resource unit “#RU2”.

The receiver 23 of the wireless communication apparatus STA checks the presence or absence of the acknowledgment frames 103 and 104 from the wireless communication apparatuses AP1 and AP2 which are requested to return an acknowledgement frame in the trigger frame 102, and determines whether the receiver 23 has received an acknowledgment frame indicating the reception success/failure result of data included in the data frame 101 (step S2).

As a result of the above-described check in step S2, if the receiver 23 has received an acknowledgment frame from at least one of the wireless communication apparatuses AP1 and AP2 which are requested to return an acknowledgment frame (Yes of step S2), the retransmission determination unit 25 determines not retransmitting data included in the data frame 101 (step S3) and ends the series of processes.

On the other hand, as a result of the above-described check in step S2, if the receiver 23 has not received an acknowledgment frame from either of the wireless communication apparatuses AP1 and AP2 which are requested to return an acknowledgment frame (No of step S2), the retransmission determination unit 25 determines retransmitting data included in the data frame 101 (step S4) and returns to the process of step S1 and executes the series of processes again.

In the present embodiment described above, it is assumed that the data frame transmitted from the data transmission side wireless communication apparatus STA includes one item of data. Therefore, an Ack frame is used as the acknowledgment frame transmitted from each of the data reception side wireless communication apparatuses AP1 and AP2.

However, the data frame transmitted from the data transmission side wireless communication apparatus STA may include a plurality of items of data. In that case, a Block Ack frame is used as the acknowledgment frame transmitted from each of the data reception side wireless communication apparatuses AP1 and AP2. Since a Block Ack frame includes information indicating the reception success/failure results of the items of data included in the data frame in the bitmap format, the data transmission side wireless communication apparatus STA can specify an item of data which is not successfully received among the items of data with reference to the Block Ack frame transmitted from each of the wireless communication apparatuses AP1 and AP2. Consequently, the data transmission side wireless communication apparatus STA can retransmit a data frame including only the item of data which is not successfully received.

In addition, although resource units, etc., are individually notified to the data reception side wireless communication apparatuses AP1 and AP2 using the AP Info fields of the trigger frame 102 in the present embodiment, resource units, etc., are not necessarily notified in this manner but may be notified as information in the MAC header of the data frame 101. In this case, transmission of the trigger frame 102 can be omitted.

Furthermore, although resource units, etc., are individually notified to the data reception side wireless communication apparatuses AP1 and AP2 using the AP Info fields of the trigger 102 in the present embodiment, resource units, etc., are not necessarily notified in this manner. For example, a resource unit used when a wireless communication apparatus which is the original destination of the data frame 101 (the wireless communication apparatus AP1 in the present embodiment) transmits an acknowledgment frame may be set to “#RU1” and a resource unit used when a wireless communication apparatus which is not the original destination of the data frame 101 (the wireless communication apparatus AP2 in the present embodiment) transmits an acknowledgment frame may be set to “#RU2” in the respective data reception side wireless communication apparatuses in advance. In this case, the AP Info fields of the trigger frame 102 can be omitted, or the transmission of the trigger frame 102 can be omitted.

Furthermore, OFDMA is used as the multiuser multiplexing communication in the present embodiment, the multiuser multiplexing communication is not limited to this, and the other multiuser multiplexing communication may be used for the transmission of the acknowledgment frame. In this case, the only difference from the present embodiment is the type of communication resource designated as the resource unit in the trigger frame 102. Examples of the type of communication resource are frequency, code, space, time, and the like. For example, when CDMA is used as the multiuser multiplexing communication, a code which is used when an acknowledgment frame is transmitted is designated as a resource unit in the trigger frame 102. In addition, when TDMA is used as the multiuser multiplexing communication, a transmission time at an acknowledgment frame is transmitted is designated as a resource unit in the trigger frame 102.

The trigger frame 102 notifies different communication resources (resource units) to a plurality of data reception side wireless communication apparatuses as described above. Different communication resources (different resource units) are communication resources (resource units) which are different in terms of at least one of frequency, code, space and time, may be any communication resources as long as frames transmitted using different communication resources can be separated on the frame reception side, and may be orthogonal in terms of at least one of frequency, code, space and time.

According to the first embodiment described above, the data transmission side wireless communication apparatus requests a plurality of data reception side wireless communication apparatuses including the original destination of a data frame to return an acknowledgment frame indicating the reception success/failure result of data included in the data frame, and always forms a plurality of wireless links with the data reception side wireless communication apparatuses. Consequently, when transmission of data included in the data frame has succeeded in one of the formed wireless links including the wireless link with the original destination, even if transmission of data included in the data frame has failed in the wireless link with the original destination (for example, even if transmission of the data frame has failed due to influence such as noise or interference), data included in the data frame can still be transmitted (transferred) to the original destination from a wireless communication apparatus in which reception of data included in the data frame has succeeded. That is, it is possible to execute highly-reliable wireless communication using the route diversity effect.

In a general communication method which can produce the route diversity effect by controlling the path switching, if transmission of data included in the data frame has failed, the path to the destination is switched from the path used for previous transmission to the other path, and the data included in the data frame is retransmitted. According to this method, redundancy can be provided to the path, and highly-reliable wireless communication using the route diversity effect can be performed.

However, even if transmission of data included in the data frame has succeeded by the switched path, since data included in the data frame needs to be retransmitted, it takes time until transmission succeeds, and it is difficult to handle instantaneous degradation of communication quality.

On the other hand, according to the present embodiment, in one transmission of a data frame, the data transmission side wireless communication apparatus requests a plurality of data reception side wireless communication apparatuses to return an acknowledgment frame indicating the reception success/failure result of data included in the data frame, and always forms a plurality of wireless links with the data reception side wireless communication apparatuses. Therefore, path switching is not a precondition, and instantaneous degradation of communication quality can be handled (robust communication can be performed even when communication quality is instantaneously degraded). Consequently, the above-described disadvantage can be solved.

Furthermore, according to the present embodiment, the data transmission side wireless communication apparatus designates different resources units as resource units which are used when the data reception side wireless communication apparatuses transmit acknowledgment frames, respectively, and the acknowledgment frames are transmitted by multiuser multiplexing communication. Therefore, interference associated with the simultaneous transmission of acknowledgment frames by the data reception side wireless communication apparatuses can be prevented. That is, it is possible to suppress occurrence of a situation where the acknowledgment frames transmitted from the data reception side wireless communication apparatuses collide and the acknowledgment frames are not correctly delivered to the data transmission side wireless communication apparatus or a situation where degraded acknowledgment frames are received by the data transmission side wireless communication apparatus.

### Second Embodiment

FIG. 9 shows the general outline of the operation of a wireless communication system in the second embodiment. The wireless communication system in the second embodiment differs from that of the first embodiment in that not only the data reception side wireless communication apparatuses AP1 and AP2 but also the data transmission side wireless communication apparatus STA transmit data frames 101A and 101B and trigger frames 102A and 102B using multiuser multiplexing communication. In the present embodiment, it is assumed that data set in (the payload portion of) the data frame 101A and data set in (the payload portion of) the data frame 101B are the same.

Firstly, the data transmission side wireless communication apparatus STA forms the data frame 101A and the trigger frame 102A which are directed to the data reception side wireless communication apparatus AP1, and integrates the data frame 101A and the trigger frame 102A into one physical frame.

Similarly, the wireless communication apparatus STA forms the data frame 101B and the trigger frame 102B which are directed to the data reception side wireless communication apparatus AP2, and integrates the data frame 101B and the trigger frame 102B into one physical frame. As described above, the data set in the payload portion of the data frame 101A and the data set in the payload portion of the data frame 101B are the same.

The physical frame including the data frame 101A and the trigger frame 102A, and the physical data including the data frame 101B and the trigger frame 102B are multiplexed and simultaneously transmitted to the destinations, that is, the wireless communication apparatuses AP1 and AP2. Note that multiuser multiplexing communication which is used when the wireless communication apparatus STA transmits frames may be any of the above examples of the multiuser multiplexing communication. FIG. 9 shows a case where OFDMA is used as the multiuser multiplexing communication.

As information notified to the wireless communication apparatus AP1, information requesting that an acknowledgment frame notifying whether data included in the data frame 101A has been received without error or not (whether reception has succeeded or not) should be returned by OFDMA using a designated resource unit is set in the trigger frame 101A. Similarly, as information notified to the wireless communication apparatus AP2, information requesting that an acknowledgment frame notifying whether data included in the data frame 102B has been received without errors or not (whether reception has succeeded or not) should be returned by OFDMA using a designated resource unit is set in the trigger frame 102B.

Note that, as is the case with the first embodiment, the resource unit assigned to the wireless communication apparatus AP1 and the resource unit assigned to the wireless communication apparatus AP2 are different from each other. That is, the resource unit designated in the trigger frame 102A and the resource unit designated in the trigger frame 102B are different from each other.

In addition, at least information notified to the wireless communication apparatus AP1 is set in the trigger frame 102A, but information notified to the wireless communication apparatus AP2 may also be set in the trigger frame 102A. Similarly, at least information notified to the wireless communication apparatus AP2 is set in the trigger frame 102B, but information notified to the wireless communication apparatus AP1 may also be set in the trigger frame 102B.

When the wireless communication apparatus AP1 receives the data frame 101A and the trigger frame 102A and if the wireless communication apparatus AP1 recognizes that the data frame 101A is directed to the own apparatus, the wireless communication apparatus AP1 checks whether the wireless communication apparatus AP1 has received data included in the data frame 101A without error or not. If the reception has succeeded, the wireless communication apparatus AP1 transmits an acknowledgment frame 103 directed to the wireless communication apparatus STA using the resource unit “#RU1” designated by the trigger frame 102A. Note that the acknowledgment frame 103 is transmitted after the elapse of SIFS from the trailing end of the trigger frame 102A.

In addition, when the wireless communication apparatus AP2 receives the data frame 101B and the trigger frame 102B and if the wireless communication apparatus AP2 recognizes that the data frame 101B is directed to the own apparatus, the wireless communication apparatus AP2 checks whether the wireless communication apparatus AP2 has received data included in the data frame 101B without errors or not. If the reception has succeeded, the wireless communication apparatus AP2 transmits an acknowledgment frame 104 directed to the wireless communication apparatus STA using the resource unit “#RU2” designated by the trigger frame 102B. As is the case with the above-described acknowledgment frame 103, the acknowledgment frame 104 is transmitted after the elapse of SIFS from the trailing end of the trigger frame 102B.

Consequently, the acknowledgment frames 103 and 104 which the wireless communication apparatuses AP1 and AP2 transmit are multiplexed using different resource units designated by the trigger frames 102A and 102B (in this case, the resource units “#RU1” and “#RU2”) and are simultaneously transmitted to the destination wireless communication apparatus STA.

If the wireless communication apparatus STA receives at least one of the acknowledgment frame 103 transmitted from the wireless communication apparatus AP1 and the acknowledgment frame 104 transmitted from the wireless communication apparatus AP2, the wireless communication apparatus STA determines not retransmitting data commonly included in the data frames 101A and 101B.

According to the second embodiment described above, when a plurality of data frames including the same data are multiplexed and transmitted, if the data transmission side wireless communication apparatus STA receives at least one acknowledgment frame, the data transmission side wireless communication apparatus STA recognizes that the data reception side wireless communication apparatuses (the wireless communication apparatuses AP1 and AP2 in the present embodiment) have received the data commonly included in the data frames without errors, and determines not retransmitting the data.

In addition, the wireless communication system of the present embodiment is substantially the same as that of the first embodiment except that the frames to be transmitted from the data transmission side wireless communication apparatus STA are multiplexed. Therefore, as a matter of course, various effects which are substantially the same as those of the first embodiment can be produced.

According to at least one of the above-described embodiments, highly-reliable wireless communication which can handle instantaneous degradation of communication quality can be realized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication apparatus comprising:
transmitter circuitry configured to transmit a first frame including first data;
receiver circuitry configured to receive, if the first frame is received by at least a first wireless communication apparatus and a second wireless communication apparatus, a second frame indicating a reception status of the first data by the first wireless communication apparatus using a first communication resource and a third frame indicating a reception status of the first data by the second wireless communication apparatus using a second communication resource different from the first communication resource; and
control circuitry configured to determine not retransmitting the first data if at least one of the reception status of the first data indicated by the second frame and the reception status of the first data indicated by the third frame indicates that reception has succeeded.

2. The wireless communication apparatus of claim 1, wherein the receiver circuitry is configured to receive the second frame and the third frame which are multiplexed using the first communication resource and the second communication resource.

3. The wireless communication apparatus of claim 1, wherein the first communication resource and the second communication resource are different from each other in at least one of frequency, code, space and time.

4. The wireless communication apparatus of claim 1, wherein the control circuitry is configured to determine retransmitting the first data if both the reception status of the first data indicated by the second frame and the reception status of the first data indicated by the third frame indicate that reception has failed.

5. The wireless communication apparatus of claim 1, wherein the transmitter circuitry is configured to transmit a fourth frame which requests the first wireless communication apparatus to transmit the second frame and requests the second wireless communication apparatus to transmit the third frame.

6. The wireless communication apparatus of claim 5, wherein
the fourth frame includes information commonly notified to the first wireless communication apparatus and the second wireless communication apparatus, and information individually notified to the first wireless communication apparatus and the second wireless communication apparatus, and
the information individually notified to the first wireless communication apparatus and the second wireless communication apparatus includes:
first identification information identifying the first wireless communication apparatus and first communication resource information indicating the first communication resource used by the first wireless communication apparatus in association with each other; and
second identification information identifying the second wireless communication apparatus and second communication resource information indicating the second communication resource used by the second wireless communication apparatus in association with each other.

7. The wireless communication apparatus of claim 5, wherein the transmitter circuitry is configured to transmit the fourth frame before transmitting the first frame or after transmitting the first frame.

8. The wireless communication apparatus of claim 5, wherein the first frame and the fourth frame are integrated into one physical frame.

9. The wireless communication apparatus of claim 1, wherein the transmitter circuitry is configured to transmit the first frame including information requesting the first wireless communication apparatus to transmit the second frame and information requesting the second wireless communication apparatus to transmit the third frame.

10. A wireless communication apparatus comprising:
receiver circuitry configured to receive a first frame including first data; and
transmitter circuitry configured to transmit, if reception of the first data has succeeded, a second frame indicating a reception status of the first data to a transmission source of the first frame using a first communication resource designated by the transmission source, wherein
the transmitter circuitry is configured to transmit the second frame multiplexed with a third frame, the third frame indicating a reception status of the first data transmitted using a second communication resource different from the first communication resource by the other wireless communication apparatus which has received the first data, the second frame multiplexed with the third frame using the first communication resource and the second communication resource.

11. A wireless communication apparatus comprising:
transmitter circuitry configured to multiplex and transmit a first data frame including first data and a first address and a second data frame including the first data and a second address;
receiver circuitry configured to receive, if the first data frame is received by a first wireless communication apparatus of the first address and the second data frame is received by a second wireless communication apparatus of the second address, a first acknowledgment frame indicating a reception status of the first data by the first wireless communication apparatus using a first communication resource and a second acknowledgment frame indicating a reception status of the first data by the second wireless communication apparatus using a second communication resource different from the first communication resource; and
control circuitry configured to determine not retransmitting the first data if at least one of the reception status of the first data indicated by the first acknowledgment frame and the reception status of the first data indicated by the second acknowledgment frame indicates that reception has succeeded.

12. The wireless communication apparatus of claim 11, wherein
the receiver circuitry is configured to receive the first acknowledgment frame and the second acknowledgment frame which are multiplexed using the first communication resource and the second communication resource.

13. The wireless communication apparatus of claim 11, wherein the first communication resource and the second communication resource are different from each other in at least one of frequency, code, space and time.

14. The wireless communication apparatus of claim 11, wherein the control circuitry is configured to determine retransmitting the first data if both of the reception status of the first data indicated by the first acknowledgment frame and the reception status of the first data indicated by the second acknowledgment frame indicate that reception has failed.

15. The wireless communication apparatus of claim 11, wherein the transmitter circuitry is configured to transmit a first trigger frame requesting the first wireless communication apparatus to transmit the first acknowledgment frame and a second trigger frame requesting the second wireless communication apparatus to transmit the second acknowledgement frame.

16. The wireless communication apparatus of claim 15, wherein
the first trigger frame and the second trigger frame include information commonly notified to the first wireless communication apparatus and the second wireless communication apparatus and information individually notified to the first wireless communication apparatus and the second wireless communication apparatus, and
the information individually notified to the first wireless communication apparatus includes first communication resource information indicating the first communication resource used by the first wireless communication apparatus, and
the information individually notified to the second wireless communication apparatus includes second communication resource information indicating the second communication resource used by the second wireless communication apparatus.

17. The wireless communication apparatus of claim 15, wherein the transmitter circuitry is configured to transmit the first trigger frame and the second trigger frame before transmitting the first data frame and the second data frame or after transmitting the first data frame and the second data frame.

18. The wireless communication apparatus of claim 15, wherein the first data frame and the first trigger frame are integrated into one physical frame, and the second data frame and the second trigger frame are integrated into one physical frame.

19. The wireless communication apparatus of claim 11, wherein the transmitter circuitry is configured to transmit the first data frame including information requesting the first wireless communication apparatus to transmit the first acknowledgment frame, and to transmit the second data frame including information requesting the second wireless communication apparatus to transmit the second acknowledgment frame.
